(19) United States
(12) Patent Application Publication
(10) Pub. No.: US 2010/0058355 A1
(43) Pub. Date: Mar. 4, 2010

(54) FIREWALL DATA TRANSPORT BROKER

(75) Inventor: Michael E. Gernaey, Bellevue, WA (US)

Correspondence Address: MICROSOFT CORPORATION, ONE MICROSOFT WAY, REDMOND, WA, 98052, US

(73) Assignee: Microsoft Corporation, Redmond, WA (US)

(21) Appl. No.: 12/202,354

(22) Filed: Sep. 1, 2008

(51) Int. Cl. G06F 13/00; G06F 17/00

(52) U.S. Cl. 719/313; 726/11; 707/100; 707/E17.001

(57) ABSTRACT

A message broker system is described that allows exchanging data reliably through a firewall without introducing firewall exceptions. The message broker system uses a broker running on each side of the firewall and a database. The sending broker creates a localized transaction between the local sender and the database. The sending broker then submits the message into the database. The sending broker also creates a state for the message that indicates the progress of the message through the process of delivering it to the recipient. On the other side of the firewall, the receiving broker pulls the data from the database, changing the state of the message to a pending and/or retrieved state. The receiving feed then creates a localized transaction with the local destination. After that transaction completes, the receiving broker marks the state of the message completed in the database.

### BACKGROUND

Most large organizations have separate network domains for different functionality. Members of some domains may have access to sensitive organization data (e.g., source code, financial data, and so forth) to which members of other domains do not have access. These domains typically have a firewall between them that limits access from a restricted (i.e., external) domain to less restricted (i.e., internal) domains. The purpose of such firewalls is to allow members of different domains to communicate, but block, or at least control, the transfer of sensitive organizational data between domains. However, there are often legitimate reasons to send data back and forth between systems on these separate domains. With a firewall, the external domains are not able to send data to the internal domains unless an administrator has explicitly opened ports used by the sending application (e.g., a firewall exception). Firewall exceptions often involve high-level approval within the organization (e.g., a vice-president or above) and thus are costly and dangerous, because they open the domain up for attacks and theft of sensitive data.

Previous attempts to solve this problem involve Microsoft Message Queuing (MSMQ), a database (e.g., SQL Server), or file shares. Each of these solutions has different problems. MSMQ is a messaging protocol that allows applications running on disparate servers to communicate in a failsafe manner. Message queues provide an asynchronous communications protocol, meaning that the sender and receiver of the message do not need to interact with the message queue at the same time. Messages placed onto the queue are stored until the recipient retrieves them. A queue is a temporary storage location from which a queue management application can send messages when conditions permit. This enables communication across heterogeneous networks and between computers that may not be continuously connected. By contrast, sockets and other network protocols assume that direct connections exist. MSMQ uses a Distributed Transaction Coordinator (DTC) to handle transactional data records. DTC does not work through a firewall without opening firewall ports, and thus is not suitable for users on different domains. Applications can also use MSMQ non-transactionally (e.g., using what are called single transactions). However, non-transactional data transfer means that any data lost will appear to the sender to have been delivered, but will in fact have never reached the receiver.

A database itself is not transactional through the firewall, so without state management and localized transactions to the destination/source it is possible for messages to be lost. Domain members can merely drop files in a file share and have them picked up by a member of another domain. However, this is not a very secure solution. In addition, it is completely non-transactional and provides no state management or potency of the files. If a system were to fail while processing a file that it picked up, it is possible that the file could be lost. Even if the system processed the file before deleting the source, if the delete failed, the system could be stuck with the inability to continue processing and would have to build in state management and idempotency. Idempotence describes the property of operations in mathematics and computer science that yield the same result when the operation is applied multiple times, a relevant concept when dealing with data transfer.

### SUMMARY

A message broker system is described that allows users and systems with different levels of access to a network (e.g., through a firewall and/or on different domains) to exchange data reliably. In some embodiments, the message broker system uses a software broker service running on a computing system on each side of the firewall. The broker system also includes a database, typically located on the external side of the firewall since both the internal and external computing systems can access data on the external side. The sending broker creates a localized transaction between the local sender and the database. The sending broker then submits the message into the database, using substantially unique identifiers for each message for idempotency. The sending broker also creates a “state” for the message that indicates the progress of the message through the process of delivering it to the recipient. On the other side of the firewall, the receiving broker pulls the data from the database, changing the state of the message to a pending and/or retrieved state. The receiving feed then creates a localized transaction with the local destination. After that transaction completes, the receiving broker marks the state of the message completed in the database.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of the message broker system in a typical operating environment, in one embodiment.

FIG. 2 is a table that illustrates the contents of a message queue used by the message broker system for storing messages, in one embodiment.

FIG. 3 is a flow diagram that illustrates the processing of the message broker system to deliver a message through the firewall, in one embodiment.

FIG. 4 is a flow diagram that illustrates the processing of the receiving broker to receive a message from the sending application and store it for delivery to the receiving application, in one embodiment.

FIG. 5 is a flow diagram that illustrates the processing of the sending broker to pull a new message from the queue, in one embodiment.

FIG. 6 is a flow diagram that illustrates the processing of the sending broker to deliver a message to a processing application, in one embodiment.

### DETAILED DESCRIPTION

A message broker system is described that allows users and systems with different levels of access to a network (e.g., through a firewall and/or on different domains) to exchange data reliably. The message broker system allows users to bridge the gap between an extranet and an intranet through different transports and security models. The system creates a way to transport data from and to processing programs that exists on one side of a firewall while the producer of the original data and consumer of the response exist on the other side of the firewall. The system provides a secure, fast, reliable, trackable, and resumable communication channel between these domains without requiring an exception through the firewall, and thus without the dangers and costs of a firewall exception. Unlike previous solutions, the message broker system transfers data in a way that allows for transactional, state managed idempotency of messages without requiring large hardware infrastructure costs or bi-directional ports through the firewall.

From the internal domain, the broker pulls and pushes messages transactionally, idem potently, and using state management to an external database (e.g., SQL Server) that temporarily stores the messages in binary format. The broker also stores metadata with the messages, such as a time the messages arrived and a source identifier for each message. The broker creates in and out feeds that place data into or remove data from the database and finalize the transport on either side of the firewall. The message broker system controls idempotency and state management throughout the process and uses localized transactions to secure transport of data to the final destination. In some embodiments, the broker includes many off-the-shelf components through configuration of the components to achieve the advantages described herein with a small infrastructure footprint and small memory requirements. This allows users to use a very small hardware and software footprint, without requiring them to create expensive infrastructures or customer software solutions.

In some embodiments, the message broker system uses DTC for the local transactions on each side of the firewall. When a technology attaches itself to a DTC transaction, the technology can easily tell DTC that it completed the action protected by the transaction, when it really did not. DTC does not guarantee that the work happened, only that it was told that the work happened. Thus, the system can inform DTC that the work was completed when the local transaction has completed, and DTC will inform the application, for example, that the message was submitted. Internally, the message broker has assumed responsibility for the message and will ensure that the original purpose of the transaction is fulfilled, namely delivering the message with guaranteed state and idempotency.

In some embodiments, the message broker system uses a software broker service running on a computing system on each side of the firewall. The broker system also includes a database, typically located on the external side of the firewall since both the internal and external computing systems can access data on the external side. The broker services on each side of the firewall communicate with the database using a push pull typology. The sending broker (e.g., either broker depending on the side of the firewall from which the system receives the message) creates a localized transaction between the local sender and the database. The sending broker then submits the message into the database, using substantially unique identifiers for each message for idempotency. The sending broker also creates a “state” for the message that indicates the progress of the message through the process of delivering it to the recipient. On the other side of the firewall, a feed from the receiving broker pulls the data from the database, changing the state of the message to a pending and/or retrieved state. The receiving feed then creates a localized transaction with the local destination. After that transaction completes, the receiving broker marks the state of the message completed in the database.

Any failure of the message to reach a completed state results in the broker rolling back the state locally or the message being put into a “poison” queue. The poison queue ensures that the system does not receive or send the same message more than one time to guarantee idempotency. This protects the transactions, while allowing safe communication through the firewall. In some embodiments, the system receives a poison Universal Resource Identifier (URI) during configuration that specifies the location to place messages with defects. For example, the poison URI may specify an MSMQ queue, a file, another database, an FTP folder, and so forth.

In some embodiments, an administrator can manually instruct the system to take a specific action with respect to messages in the poison queue. For example, if the administrator knows that a network outage caused messages in the queue at a particular time to fail delivery, then the administrator can instruct the system to place those messages back into the normal queue for completion in the normal manner. The administrator's knowledge of the situation ensures that state management and idempotency guarantees are not violated.

The broker applies state management principals to each step it performs. Like other technologies, there is no unified transactional support through a firewall without opening ports on both sides. However, the broker interacts with the components on each side of the firewall through separate transactions to ensure a well-known state at all times. This means whether the broker is using a database (e.g., SQL Server) or a message queue implementation (e.g., MSMQ), the broker uses transactions to get and write data and to return the response to a processing application. Thus, the message broker system can guarantee the state of the message at each stage, giving the same effect as a unified transaction around the process.

In some embodiments, the broker uses stages for pulling data. The sending broker (e.g., on the extranet side) receives data transactionally from the application on its side of the firewall and stores the data in a submitted state in the database. The receiving broker (e.g., on the intranet side) pulls data from the database and attempts to write that data using a specified transport (e.g., MSMQ, FTP, and so on), to a specified location. The broker, is a broker, not because it can store and forward messages, but because it can change the format and or the transport of the destination and target systems, whether on the same subnet, on another subnet or across a firewall. The receiving broker does the write to the local technology transactionally and once this has been configured it changes the state of the message to pending. If the broker could not successfully write a message or the broker has not processed the record yet, even if the broker was shut off the state would stay submitted and the message would be re-processed when the broker restarted.

In some embodiments, the broker time stamps each state change and stores extra information with the data as metadata. For example, the broker may store the timestamp as metadata, a message identifier (e.g., a GUID) for the system to track the message, a transport identifier (e.g., GUID) for the sender to identify the message, and a correlation identifier (e.g., a GUID) that the sending application uses to correlate the message and response. In some cases, the broker may send a message across multiple network hops, and the system uses the correlation identifier to report to the sender each hop associated with the message. The broker uses the transport identifier to block duplicate delivery of a message. If the broker receives a message with the same transport identifier as a previous message, then the broker will flag the new message as a duplicate and move it to the poison queue. If at any point the connection to SQL, MSMQ or other system elements fails, then the state of the message and the idempotency of the message will prevent the system from delivering it again, but allows delivery of the message to continue later when the broker restarts and the system elements are available again.

In some embodiments, after the system sends a message to the receiving application, the broker waits for confirmation (e.g., an acknowledgement from MSMQ, a receipt from a processing application such as BizTalk, or a FileIOCompletion from a file system) that the message reached the queue successfully to validate that the message got to its intended destination. The broker then sets the message state to either Completed Success or Complete With Errors, depending on the response from the receiving application. The sending application can retrieve this acknowledgement as a response message from the receiving application or the message broker system. The response may contain the correlation identifier so that the sending application can correlate the response to the original message.

In some embodiments, the message broker system receives configuration information from a processing application or administrator that describes the transport to use for messages and the destination location to deliver the messages. For example, an administrator may provide an XML file that describes how the message broker system will treat messages for a particular application. The XML file may describe the transport used for messages by the application (e.g., MSMQ, FTP, HTTP, and so on) and the location to deliver the messages (e.g., a server IP address, DNS name, file share path, and so forth).

In some embodiments, the message broker system allows an administrator to create a template specifying the format of outgoing messages. The actual template is based not on what you type into the document but based on the fields that are used in the database. For example, when the system reads messages from the database the messages contain a message data field that stores the actual data that the sending application stored to be forwarded on by the system. When an administrator creates a template, the administrator uses the ordinal position of that column in the record set to specify where that field will be placed in the outgoing message. The following listing shows an example template used for providing data to Microsoft BizTalk through the firewall:

```
<?xml version=“1.0” encoding=“utf-16”?>
<ns0:IcoeBizTalkBroker xmlns:ns0=“http://ICOEBizTalkBroker”>
    <MESSAGEID>##0##</MESSAGEID>
    <MESSAGETYPE>##1##</MESSAGETYPE>
    <SUBMITTED>##2##</SUBMITTED>
    <MESSAGE><![CDATA[##3##]]></MESSAGE>
</ns0:IcoeBizTalkBroker>
```

In this example template, there is a schema created by an administrator using the delimiter format, ##ordinal##, where ordinal specifies a column in the database table by index. When the message broker system creates the outgoing message, it will use this template to create the message. The file is based on the encoding selected by the administrator, not just the message data column that stores the actual data. Thus, the template contains metadata from columns other than column 3, which contains the message data. Only valid ordinals and data members of the broker table, based on the message activity are valid for a given template.

In some embodiments, the message broker system supports three directional models: incoming, outgoing, and synchronous. The incoming model includes the situation where the sending broker writes messages into the database. In many cases, such as in file transports, the incoming model is used to pick up receipts and to process them to complete a transaction where a file was sent from one partner and processed somewhere else. The outgoing model includes the situation where the system reads messages from the database and writes them to a local destination, such as MSMQ or a file folder. The synchronous model includes situations where the broker is configured to process one message at a time and then to wait a specific period for a receipt, response, or acknowledgement from the receiving application to indicate that the receiving application processed and completed the message. If the timeout period expires, then the system completes the message with errors and processes the next message. Depending on the transport type, applications typically use the incoming model for processing receipts or responses from consumers of messages so that the system can complete a transaction and move message states from pending to completed. However, applications may also use the incoming model for reading in messages and other activities configured to not receive acknowledgements.

In some embodiments, the message broker system supports any incoming and outgoing encoding, including allowing an administrator to change the encoding from what it was originally to what a receiving application expects. There broker can support an unlimited number of encodings and is configurable for a particular message activity.

In some embodiments, processing applications interface with the message broker system through a web service. For example, the system may include a web server that exposes one or more web service methods that the application can use to submit and retrieve messages across the firewall. Alternatively or additionally, processing applications may interact directly with the database, such as by calling one or more stored procedures to directly insert messages for delivery or pick up received messages. The stored procedures ensure that the application follows the semantics of the system for ensuring state management and idempotency. For example, the stored procedures may include transactions around any modifications to the database tables storing messages.

In some embodiments, the message broker system provides an interface previously used by a sending and receiving application, such that the two applications cannot detect that the message broker system is being used to cross the firewall. For example, an administrator can configure two applications that are designed to communicate using MSMQ in the absence of a firewall to communicate using the message broker system via an MSMQ interface, so that the applications continue to do what they did before the firewall, but the message broker system allows the applications to work correctly through the firewall.

The following figures illustrate elements of the message broker system described herein.

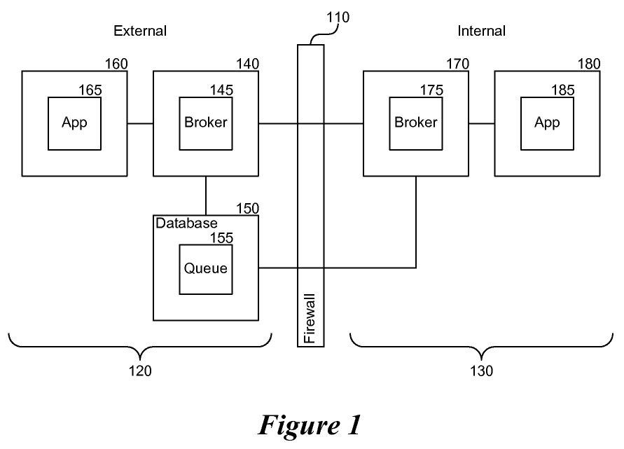

FIG. 1 is a block diagram that illustrates components of the message broker system in a typical operating environment, in one embodiment. A firewall 110 separates internal 130 and external 120 sections of a network. The sections may be domains, subnets, or other network architectures that prevent general access from to data in one section from the other section. In the illustrated example, the internal 130 section contains sensitive data and is more restrictive of access than the external 120 section. The external 120 section of the network includes a computing system 140 running a broker 145, a database 150 that includes at least one queue 155, and a computing system 160 that includes an application 165 that wants to send messages to one or more computing systems on the other side of the firewall 110.

The internal 130 section of the network includes a computing system 170 running another broker 175, and a computing system 180 running another application 185. In one scenario, the application 165 sends data to the application 185. The application 165 provides the data to the broker 145, which writes the data to the database 150. The broker 175 picks up the data and delivers the data to application 185. The message broker system ensures that the state of the message is managed at all times so that if any element of the system fails or if connectivity through any part of the network is temporarily unavailable, the message will be delivered reliably or fail with known state. The idempotency of the system will ensure that even if the application 165 submits the same message multiple times, the system will only deliver it once (e.g., using the message identifier described herein).

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

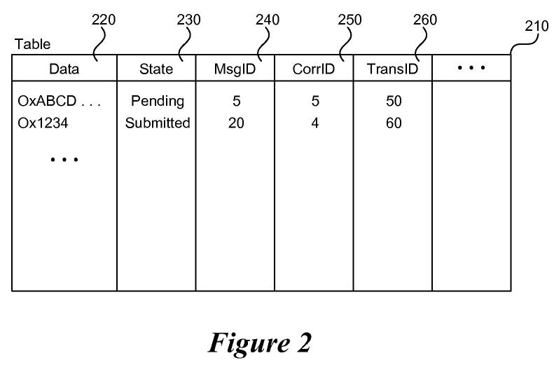

FIG. 2 is a table that illustrates the contents of a message queue used by the message broker system for storing messages, in one embodiment. The table 210 contains a data column 220, a state column 230, a message identifier column 240, a correlation identifier column 250, and a transport identifier column 260. The data column 220 contains the raw message data received from the sending application. The remaining columns are metadata stored by the message broker system for performing the functions of the system. The state column 230 contains the current state of each message and changes as the system makes progress delivering the message to the receiving application. The message identifier column 240 contains an identifier set by the system to distinguish each message from other messages managed by the system. The correlation identifier column 250 contains an identifier set by the sending application. The system or sending application may use the correlation identifier column 250, for example, to correlate responses or acknowledgements to the message with which they are associated. The transport identifier column 260 is an identifier provided by the sending application for distinguishing the message from other messages provided by the sending application. The sending application can use the transport identifier column 260 to mark retries of the same message with the same identifier so that the system knows to only deliver one copy of the message. The system can use the message identifier or message identifier in combination with the transport identifier to ensure idempotency.

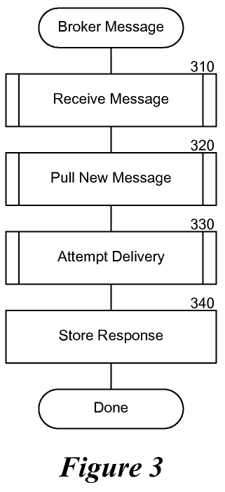

FIG. 3 is a flow diagram that illustrates the processing of the message broker system to deliver a message through the firewall, in one embodiment. In block 310, the system receives a new message from a sending application for delivery to a receiving application and places the new message in the queue. For example, a Microsoft BizTalk instance may request that the system deliver a message to an internal corporate resource. In block 320, the system identifies the new message in the queue. For example, a receiving broker may periodically poll the queue for new messages and notice the new message. In block 330, the system attempts to deliver the message to the receiving application. For example, the system may use MSMQ or another transport technology to deliver the message to the receiving application. In block 340, the system provides any response requested by the sending application. For example, the response may indicate whether the system successfully deliver the message to the receiving application. These steps are detailed further in the following flow diagrams.

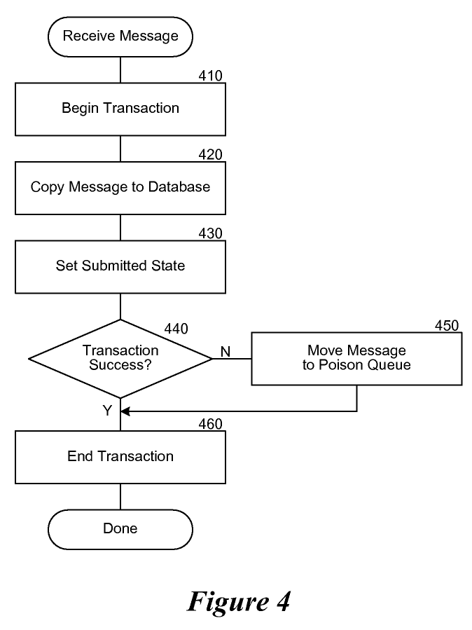

FIG. 4 is a flow diagram that illustrates the processing of the receiving broker to receive a message from the sending application and store it for delivery to the receiving application, in one embodiment. In block 410, the receiving broker opens a transaction that ensures that the following steps are completed atomically or are rolled back if they cannot be completed. In block 420, the receiving broker copies the received message to the database used by the system. For example, the database may contain a table or queue of messages at various stages of progress through the system. In block 430, the receiving broker sets the state of the new message to submitted in the database. The database tracks the state of each message at each stage. In decision block 440, if any operation within the transaction failed, then the receiving broker continues at block 450, else the broker continues at block 460. In block 450, the broker moves the new message to the poison queue and rolls back any operations that were part of the transaction. In some cases, the broker may simply leave the message in the main queue and retry the failed operations again later. In block 460, the broker closes the transaction. After block 460, these steps conclude.

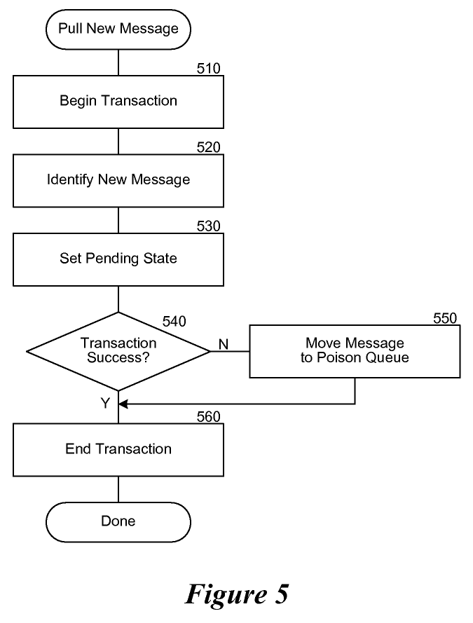

FIG. 5 is a flow diagram that illustrates the processing of the sending broker to pull a new message from the queue, in one embodiment. In block 510, the sending broker opens a transaction that ensures that the following steps are completed atomically or are rolled back if they cannot be completed. In block 520, the sending broker identifies a new message in the queue. For example, the sending broker may periodically poll the queue for new messages and use a peek operation to inspect their state without modifying the messages. In block 530, the sending broker sets the state of the identified message to pending to indicate that the sending broker has taken ownership of the message and will attempt delivery of the message. In decision block 540, if any operation within the transaction failed, then the sending broker continues at block 550, else the broker continues at block 560. In block 550, the broker moves the identified message to the poison queue and rolls back any operations that were part of the transaction. In some cases, the broker may simply leave the message in the main queue and retry the failed operations again later. In block 560, the broker closes the transaction. After block 560, these steps conclude.

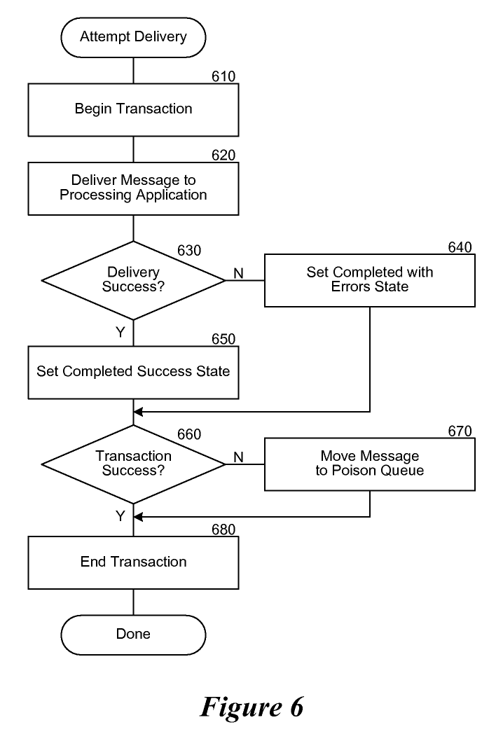

FIG. 6 is a flow diagram that illustrates the processing of the sending broker to deliver a message to a processing application, in one embodiment. In block 610, the sending broker opens a transaction that ensures that the following steps are completed atomically or are rolled back if they cannot be completed. In block 620, the sending broker attempts to deliver the message to the processing application using the transport and format identified by the configuration information described herein. For example, the sending broker may use MSMQ to provide the message from a local queue to the processing application. In decision block 630, if the delivery succeeded, then the broker continues at block 650, else the broker continues at block 640. In block 640, the broker sets the state of the message to “completed with errors.” In block 650, the broker sets the state of the message to “completed success.” In decision block 660, if any operation within the transaction failed, then the sending broker continues at block 670, else the broker continues at block 680. In block 670, the broker moves the message to the poison queue and rolls back any operations that were part of the transaction. In some cases, the broker may simply leave the message in the main queue and retry the failed operations again later. In block 680, the broker closes the transaction. After block 680, these steps conclude.

From the foregoing, it will be appreciated that specific embodiments of the message broker system have been described herein for purposes of illustration, but that various modifications may be made without deviating from the spirit and scope of the invention. For example, although transports such as MSMQ have been described, the message broker system can deliver messages across the firewall using many different types of transports, such as FTP, FTPS, HTTP, and HTTPS. Accordingly, the invention is not limited except as by the appended claims.

I/we claim:

1. A computer-implemented method for delivering messages across a firewall, the method comprising:
opening a local transaction between a sending application and a receiving broker;
receiving a message from a sending application;
copying data in the received message to a database associated with the receiving broker, wherein the database is accessible by a sending broker on an opposite side of a firewall from the receiving broker and wherein the sending broker delivers messages stored in the database to a receiving application on the opposite side of the firewall from the sending application;
setting a state of the message in the database to indicate that the message has been submitted but not picked up; and
closing the local transaction.

2. The method of claim 1 further comprising, if copying data or setting the state fails, moving the message to a poison queue of messages for which delivery failed.

3. The method of claim 1 wherein receiving the message comprises receiving the message through a web service.

4. The method of claim 1 wherein receiving the message comprises receiving the message via an invoked stored procedure.

5. The method of claim 1 wherein receiving the message comprises receiving the message via Microsoft Message Queuing (MSMQ).

6. The method of claim 1 wherein copying data comprises storing a message identifier received from the sending application with the data in the database.

7. The method of claim 1 wherein copying data comprises generating an identifier that distinguishes the message from other messages stored in the database.

8. The method of claim 1 further comprising receiving a response to the message, wherein the response contains an identifier for correlating the response with the message.

9. The method of claim 1 wherein the transaction is provided by a distributed transaction coordinator and further comprising, after setting the state, informing the distributed transaction coordinator that an action protected by the transaction has completed.

10. A computer system for transporting data between areas of a network having different restrictions, the system comprising:
a firewall configured to control access to data on a first area of the network to a second area of the network;
a database configured to store data at multiple stages of transport from one side of the firewall to the other;
a receiving broker configured to receive data sent by a sending application for transport through the firewall and store the data in the database; and
a sending broker configured to access data stored in the database and deliver it to a receiving application on the opposite side of the firewall from the sending application.

11. The system of claim 10 wherein the database is located on a side of the firewall that the receiving broker and sending broker can access without a firewall exception that explicitly opens ports on the firewall.

12. The system of claim 10 wherein the receiving and sending brokers are further configured to ensure idempotency of data by storing state management information in the database along with the data.

13. The system of claim 10 wherein the receiving broker is further configured to use a local transaction to receive data sent by the sending application.

14. The system of claim 10 wherein the sending broker is further configured to use a local transaction to deliver data to the receiving application.

15. A computer-readable medium encoded with instructions for controlling a computer system to receive a message across a firewall, by a method comprising:
identifying a new message for a sending broker in a database, wherein the database stores messages written by a receiving broker for delivery to a receiving application on the opposite side of a firewall from a sending application;
setting a state of the identified new message to indicate that the sending broker has identified the message and will attempt to deliver the message to the receiving application;
attempting to deliver the message to the receiving application; and
updating the state of the identified new message to indicate that the sending broker attempted to deliver the message.

16. The computer-readable medium of claim 15 wherein updating the state of the identified new message comprises indicating whether the attempt to deliver the message succeeded or failed.

17. The computer-readable medium of claim 15 wherein the method further comprises performing the steps of identifying the new message, setting the state, attempting to deliver the message, and updating the state within a local transaction between the sending broker and the receiving application.

18. The computer-readable medium of claim 15 further comprising if attempting to deliver the message fails, moving the message to a poison queue of messages for which the computer system has already attempted delivery.

19. The computer-readable medium of claim 15 wherein attempting to deliver the message comprises formatting data associated with the message according to an output data template.

20. The computer-readable medium of claim 15 wherein attempting to deliver the message comprises using a transport specified in configuration information received from an administrator.
